(19) United States
(12) Patent Application Publication
(10) Pub. No.: US 2024/0272871 A1
(43) Pub. Date: Aug. 15, 2024

(54) SYSTEM AND METHOD TO ACCELERATE MICROPROCESSOR OPERATIONS

(71) Applicant: Arith Inc., Palo Alto, CA (US)

(72) Inventor: David H.C. Chen, Palo Alto, CA (US)

(21) Appl. No.: 18/107,910

(22) Filed: Feb. 9, 2023

(51) Int. Cl. G06F 9/50; G06F 7/499; G06F 7/523

(52) U.S. Cl. CPC G06F 7/5525; G06F 7/49905; G06F 7/523

(57) ABSTRACT

Systems and methods are directed to accelerating operations associated with a microprocessor. Example embodiments improve the operations of the microprocessor by providing devices (e.g., integrated circuits, independent accelerators) configured to use reciprocal or reciprocal square root instructions. Such devices can be further configured to follow the reciprocal or reciprocal square root instructions with multiplication or other instructions to finish division, square root, or other complex operations.

### TECHNICAL FIELD

The subject matter disclosed herein generally relates to microprocessor operations. Specifically, the present disclosure addresses systems and methods that accelerate microprocessor computations.

### BACKGROUND

Conventionally, computing devices are used to perform operations that are used in countless applications. As an example, ray casting is an algorithm for three-dimensional (3D) gaze-to-view rendering commonly utilized in virtual, augmented, and mixed reality (VR, AR, and XR) applications. Ray casting requires a large amount of square root computations resulting in long latency and consumption of significant power. Long latency causes VR, AR, and XR to be irresponsive to users' eye, head, or body movements. High power consumption requires a VR, AR, or XR headset to embed a big and heavy battery. Finally, low bandwidth prevents photorealistic image with higher resolution. This is one example use case illustrates operational limitations of conventional microprocessors.

Binary32 format, defined by IEEE Std 754-2019, is commonly used by VR, AR, and XR engineers and others. However, the limitation of a dynamic range caused by finite bit width of exponents is inevitable for any data format, uncompressed or otherwise. A number out of the dynamic range can underflow and become zero (0) or overflow and become infinity (∞).

The binary32 format is a signed exponential format with one sign bit (S), eight exponent bits (E), 23 mantissa bits (M), and one hidden bit (H). When the sign bit (S) is 0, a represented number is positive. Otherwise, it is negative. The eight exponent bits (E) represent an integer in a range of [−126, +127] indicating a dynamic range to be in a range of [2\hat{ }−126, 2\hat{ }+127]. The hidden bit (H) is normally 1. The 23 mantissa bits (M) comprise a fraction part of the represented number.

The binary32 format represents a number with a value of (−1)\hat{ }S*(H·M)*2\hat{ }E, wherein S is either 0 or 1, E is in a range of [−126, 127], and (H·M) is normally in a range of [1.0,2.0). Thus, binary32 format can represent a nonzero normal number in a range of +[1.0, 2.0)*2\hat{ }−126 to +[1.0, 2.0)*2\hat{ }127 or −[1.0, 2.0)*2\hat{ }−126 to −[1.0, 2.0)*2\hat{ }127.

For simplicity, “significand” is denoted as an optional hidden bit followed by a plurality of mantissa bits in any data format. M is denoted as a value of the mantissa bits (e.g., 23 bits in the binary32 format). Because M is in a range of [0.0, 1.0), a significand is in the range of [1.0, 2.0) for normal numbers. In general, a numerical value is evaluated by taking the optional hidden bit into account even when only the mantissa bits are available. This is why it is referred to as a “hidden” bit.

Many CPU, GPU, Floating-Point Unit (FPU), and Digital Signal Processor (DSP) apply Newton-Raphson or Sweeney-Robertson-Tocher (SRT) algorithms for division and square root computation. Both Newton-Raphson and SRT algorithms are slow due to their iterative and recurrent natures, respectively. A fast way of computing a square root of input operand (X) is to generate a reciprocal square root (R) and then multiply the reciprocal square root with the input operand (X), as showed by the following equation:

$$√ X = X / √ X = X * 1 / √ X = X * R$$

Though the above equation is mathematically correct. Applying the equation can provide incorrect results. For example, a square root of 0 is 0. Thus, reciprocal square root (R) is 1 divided by 0, and thus equal to infinity (∞) by definition.

When the above equation is applied to compute the square root of 0, the result is X*R=0*∞=Not A Number (NaN). In Floating-Point (e.g., IEEE Std 754-2019), the equation runs into an invalid operation when trying to multiply 0 with ∞ and generates a NaN to indicate the failure to produce a numeric result.

### BRIEF DESCRIPTION OF THE DRAWINGS

Some embodiments are illustrated by way of example and not limitation in the figures of the accompanying drawings.

FIG. 1 is a diagram illustrating an exemplary system configured to accelerate computations, according to some example embodiments.

FIG. 2 is a diagram illustrating an exemplary embodiment of a device that implements various reciprocal and reciprocal square root instructions, according to some example embodiments.

FIG. 3 is a block diagram illustrating an exemplary embodiment of a device that implements various multiplication instructions, according to some example embodiments.

FIG. 4 is a block diagram illustrating a division extension, according to example embodiments.

FIG. 5 is a block diagram illustrating an independent square root accelerator, according to example embodiments.

FIG. 6 is a diagram illustrating components of an exemplary arithmetic logic unit, according to some example embodiments.

FIG. 7 is a diagram illustrating components of another exemplary arithmetic logic unit, according to some example embodiments.

FIG. 8 is a block diagram illustrating components of a machine, according to some example embodiments, able to read instructions from a machine-storage medium and perform any one or more of the methodologies discussed herein.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components) are optional and may be combined or subdivided, and operations (e.g., in a procedure, algorithm, or other function) may vary in sequence or be combined or subdivided.

Example embodiments provide a technical solution for dealing with the technical problem of accelerating operations associated with a microprocessor. Specifically, example systems and methods enable generation of significand with high precision and utilize the significand to accelerate numerical computation. Further, example systems and methods enable generation of an unbounded exponent and utilize the unbounded exponent to accelerate numerical computation. The systems and methods are suitable for arithmetic operations on fixed-point, block floating-point, and/or floating-point operands in their uncompressed or compressed formats. Furthermore, input and output operands are allowed to be in different formats. Because computations are accelerated by example embodiments, one or more of the methodologies described herein may obviate a need for certain efforts or computing resources that otherwise would be involved in conventional computational devices. Examples of such computing resources comprise processor cycles, memory usage, data storage capacity, and power consumption.

Example embodiments improve the operations of the microprocessor by using reciprocal or reciprocal square root instructions. Reciprocal or reciprocal square root instructions can provide novel instructions for a CPU, GPU, FPU, or DSP, or other microprocessors. Reciprocal or reciprocal square root instructions can also be an extension to accelerate CPU, GPU, FPU, DSP, or other microprocessors. Furthermore, reciprocal or reciprocal square root instructions can be (or be embodied within) an independent accelerator. Multiplication or other instructions may follow the reciprocal or reciprocal square root instructions to finish division, square root, or other complex operations, as will be discussed in further details below.

In accordance with some example embodiments, some instructions can disregard some mathematical equations when generating the reciprocal square root or other results. For example, a reciprocal square root instruction with an input of 0 (X) should generate +0 as an output disregarding the equation of 1/√X. Based on some example embodiments, when computing square root (√X), the aforementioned equation is modified and becomes √X [symbol] X*R by definition. This √X [symbol] X*R equation is then applied to quickly generate a correct result. In accordance with some example embodiments, instructions should be aware of intentional disregard and modification of some equations when performing the X*R or other instructions.

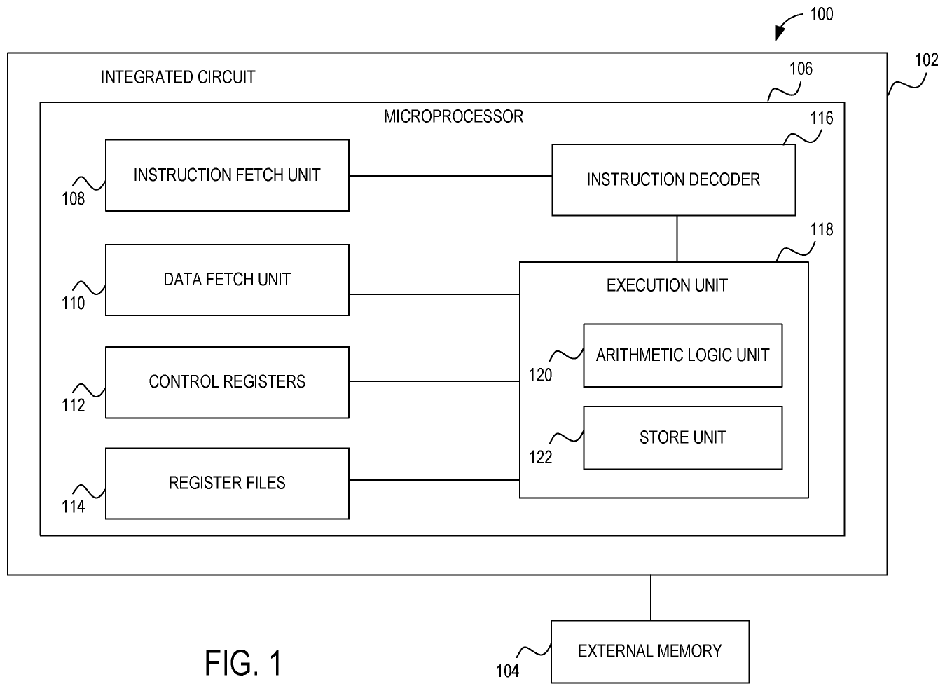

FIG. 1 illustrates an exemplary system 100 configured to accelerate computations, in accordance with example embodiments. In example embodiments, the system 100 can process values represented in various formats. The system 100 comprises an integrated circuit 102 that can be coupled to various external resources such as an input device (not shown), an output device (not shown), and/or an external memory 104. The integrated circuit 102 comprises, for example, an integrated circuit die, a printed circuit board that comprises a packaged device and/or an integrated circuit die, and/or any combination thereof.

The integrated circuit 102 comprises a microprocessor 106 such as a CPU, GPU, FPU, or DSP core. In example embodiments, the microprocessor 106 comprises an instruction fetch unit 108, a data fetch unit 110, control registers 112, register files 114, an instruction decoder 116, and an execution unit 118. The instruction fetch unit 108 is configured to fetch instruction. For example, the instructions can be fetched from the external memory 104, a cache (not illustrated), or the like. The instruction decoder 116 decodes the instructions from the instruction fetch unit 108 and sends decoded instructions to the execution unit 118. While the instruction fetch unit 108 and the instruction decoder 116 are shown as two distinct units, some embodiments can integrate the functions of the two units into a single unit. Additionally, while the instruction decode unit 116 and the data fetch unit 110 are shown as two distinct units, some embodiments can integrate the functions of the two units into a single unit.

The execution unit 118 is further coupled to the control registers 112 and the register files 114. The register files 114 can be a register set, a storage, or a combination thereof.

In example embodiments, the execution unit 118 determines a location of operands to be fetched for use by the instruction and provides the location to the data fetch unit 110. The data fetch unit 110 retrieves the requested operands from the location (e.g., the external memory 104, the register files 114, cache). The execution unit 118 performs the instruction using an arithmetic logic unit 120. When the instruction is retired, one or more resultants are provided to a store unit 122 which stores the resultants. For example, the resultants can be stored to the external memory 104, the register files 114, or the cache.

In some embodiments, reciprocal or reciprocal square root instructions can be novel instructions of the microprocessor 106. The resultant of the reciprocal or reciprocal square root instructions can be stored, for example, in the external memory 104, the register files 114, or the cache. Multiplication or other instructions may follow the reciprocal or reciprocal square root instructions to finish division, square root, or other complex operations, as will be discussed in further detail below.

Division and square root are fundamental operations for computers to precisely render and visualize two-dimensional or higher-dimensional (2D+) objects, such as, for example, generating a photorealistic 2D or 3D image of a house to be built based on a model from an architect or designer, scaling a picture to fit onto a paper for printing, resizing a video game character or virtual reality avatar as it moves forward or backward, or visualizing a 3D molecular structure. Thus, fast division and square root operations improve the functions of a computing device, improves productivity, and improves a user experience.

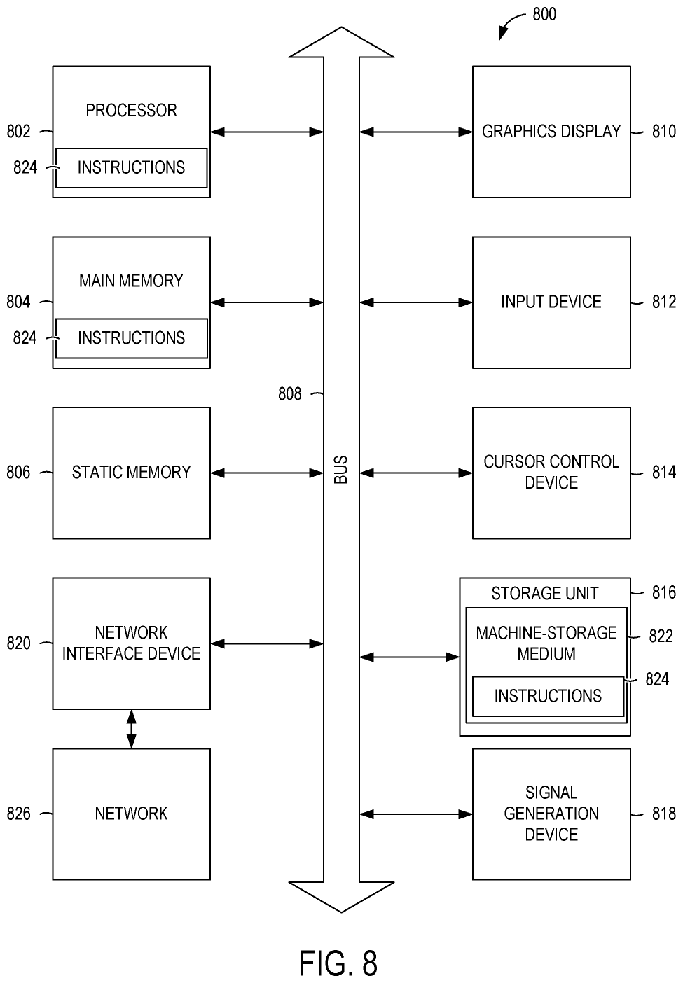

In example embodiments, any of the units, registers, files, decoders (collectively referred to as “components”) shown in, or associated with, FIG. 1 may be, comprise, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 8, and such a special-purpose computer is a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any of the components illustrated in FIG. 1 or their functions may be combined, or the functions described herein for any single component may be subdivided among multiple components. For instance, while only a single arithmetic logic unit 120 is shown, alternative embodiments contemplate having more than one arithmetic logic unit 120 to perform the different operations discussed herein (e.g., reciprocal or reciprocal square root operations; multiplication and division operations). As another example, the functions of the instruction fetch unit 108 and the instruction decoder 116 can be combined into a single unit.

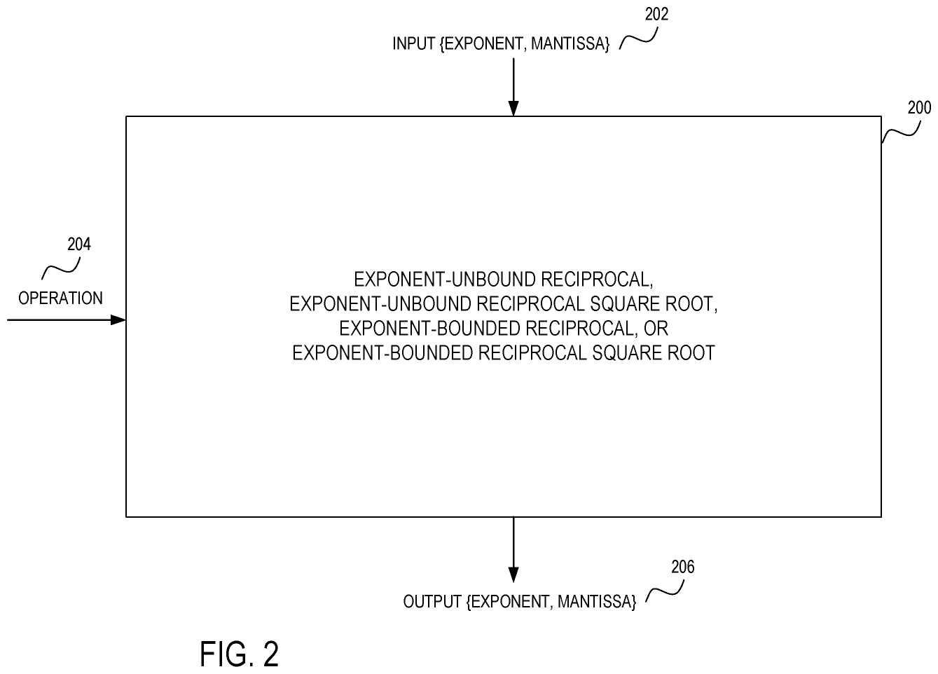

FIG. 2 is a diagram illustrating an exemplary embodiment of a device 200 that implements various reciprocal and reciprocal square root instructions, according to some example embodiments. In some embodiments, the device 200 is an arithmetic logic unit (e.g., arithmetic logic unit 120). In other embodiments, the device 200 is an accelerator. The device 200 receives an input 202 (e.g., an input operand) which comprises an exponent and mantissa bits. The exponent and the mantissa bits can be represented in any suitable formats, with various bit widths, biased or not, with a hidden bit or not, encoded or not, compressed or not. The device 200 may be controlled by an operation 204 which instructs the device 200 to perform reciprocal or other instructions in accordance with example embodiments. In some embodiments, the operation 204 is issued by an instruction decoder (e.g., the instruction decoder 116) of a CPU, GPU, FPU, DSP, or other microprocessor (e.g., the microprocessor 106). In example embodiments, the input 202 can be received from a register file (e.g., the register file 114) via a register file output port, and an output 206 (e.g., an output operand) can be transmitted, for example, to a register file (e.g., the register file 114) via a register file input port.

When instructed by the operation 204 to perform the reciprocal instruction, the device 200 generates the output 206 which comprises mantissa bits with a value in a range of [1.0, 2.0) for a non-zero finite numeric input. In order to have the significand be in such a range, the device 200 may compute as though the exponent is unbounded by any format, bit width, bias, or otherwise. When an input (e.g., input 202) is zero, infinity, or non-numeric, the device 200 may compute as if the input is a non-zero finite numeric or compute according to a standard associated with a corresponding data format (e.g., IEEE 754-2019). This instruction may be referred to as “Exponent-Unbounded Reciprocal.”

The output 206 may optionally comprise an exponent output. For example, when the output should be 1.0*2\hat{ }−127 (e.g., exponent is −127) but the minimum representable exponent is −126, the device 200 may optionally generate an exponent output with a value of −1 to indicate the output exponent is one less than the minimum representable output.

Multiplication can be an instruction of the CPU, GPU, FPU, DSP, or another microprocessor (e.g., the microprocessor 106). Multiplication can also be an extension to accelerate the CPU, GPU, FPU, DSP, or another microprocessor. In some embodiments, multiplication instructions can be (or be embodied within) an independent accelerator.

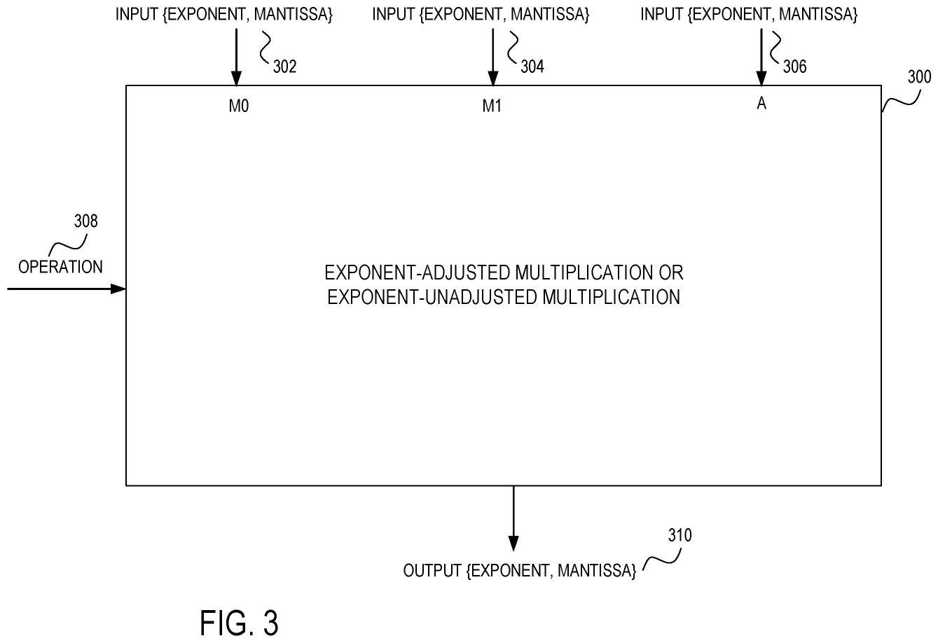

FIG. 3 is a block diagram illustrating an exemplary embodiment of a device 300 that implements various multiplication instructions, according to some example embodiments. In some embodiments, the device 300 is an arithmetic logic unit (e.g., arithmetic logic unit 120). In other embodiments, the device 300 is an accelerator. The device 300 receives multiple inputs: a first operand 302 and a second operand 304 and, optionally, a third operand 306. The first operand 302 can be a reciprocal generated by the device 200 of FIG. 2 performing Exponent-Unbounded Reciprocal. The second operand 304 can be a numerator (N). The optional third operand 306 can be a denominator (D).

In example embodiments, the device 300 multiplies the first operand 302 with the second operand 304 and optionally adjusts an exponent to generate a correct result. The device 300 may be controlled by an operation 308 which instructs the device 300 to perform a multiplication with exponent adjustment. Such an instruction can be referred to as “Exponent-Adjusted Multiplication.” In some embodiments, the operation 308 is issued by an instruction decoder (e.g., the instruction decoder 116) of the CPU, GPU, FPU, DSP, or another microprocessor (e.g., the microprocessor 106). The first operand 302, the second operand 304, and the optional third operand 306 can be received from register file output ports of a register file (e.g., the register file 114). An output of the device 300 can be transmitted to a register file input port of a register file (e.g., the register file 114).

In example embodiments, the device 300 adjusts the exponent in one of several ways. In a first manner, if the device 300 receives an external exponent (e.g., an exponent output from the output 206) from the first input 302 directly or via a format converter, the device 300 may use the external exponent to adjust the exponent. For example, when the device 300 realizes that the external exponent is −1 (e.g., one less than the representable minimum), the device 300 understands the reciprocal is actually 1.0*2\hat{ }−127. The device 300 multiplies 1.0*2\hat{ }−127 with 1.0*2\hat{ }127 and generates 1.0 as the correct result (e.g., output 310).

In a second manner, the device 300 may internally generate an exponent output based on the same exponent from the third input operand 306 (e.g., a same denominator exponent) by performing the same calculation as in the device 200 of FIG. 2. The device 300 uses the internal exponent output to generate the same correct result since the internal exponent output is numerically equal to the external exponent output.

Example embodiments are also applicable to square root and other operations. To compute square root, many conventional CPU, GPU, FPU, and DSP apply the same families of iterative and recurrent slow algorithms as for division. Example embodiments, however, provide a fast way to compute square root. For example, referring back to FIG. 2, square root can be performed in two steps. For instance, operation 204 may instruct the device 200 to perform reciprocal square root, instead of reciprocal, by switching among various ways to generate the output 206 based on whether the input operand 202 is zero (±0), infinity (±∞), Not a Number (e.g., signaling or quiet NaN in IEEE Std 754-2019), or finite non-zero number. This instruction is referred to as “Exponent-Unbounded Reciprocal Square Root.”

When instructed by the operation 204 to perform Exponent-Unbounded Reciprocal Square Root, the device 200 generates the output 206 in the following manner in accordance with example embodiments. When an input (e.g., input 202) is a non-zero finite number, the device 200 may compute according to the equation of 1/√X and generate the output 206. If the input (e.g., input 202) is zero (±0) or positive infinity (+∞), the device 200 may perform an absolute operation (|X|) instead and generate an absolute value as the output 206. If the input (e.g., input 202) is non-numeric (e.g., NaN in IEEE Std 754-2019) or negative infinity (−∞), the device 200 may generate a non-numeric (e.g., NaN in IEEE Std 754-2019) as the output 206.

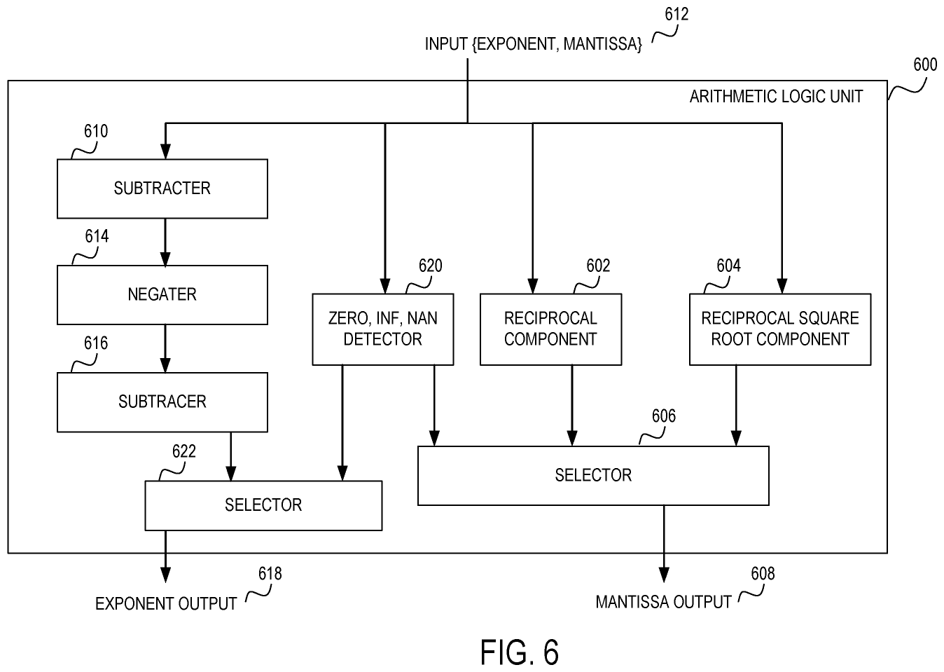

In some embodiments, the device 200 may be implemented according to FIG. 6. In FIG. 6, a detector 620 is configured to recognize and forward bit patterns of zeros, infinities, and non-numeric. The detector 620 checks an input 612 to detect whether the input is zero (0), infinity (∞), or non-numeric (e.g., NaN in IEEE Std 754-2019) by, for example, comparing the input 612 with the bit patterns. When performing Exponent-Unbounded Reciprocal Square Root, if a positive or negative zero (±0) is detected, the detector 620 sends a positive zero (+0) to selector 606 and selector 622. If a positive infinity (+∞) is detected, the detector 620 sends a positive infinity (+∞) to the selectors 606 and 622. If a non-numeric (e.g., NaN in IEEE Std 754-2019), a negative infinity (−∞), or a negative non-zero finite is detected, the detector 620 sends a non-numeric to the selectors 606 and 622. The selectors 606 and 622 may forward what they receive from the detector 620 as mantissa output 608 and exponent output 618, respectively. If none of zeros, infinities or non-numeric is detected (e.g., the input operand is positive non-zero finite), the detector 620 sends nothing (null) to the selectors 606 and 622. In this case, the selector 606 outputs the resultant from the reciprocal square root component 604. Implementation may concatenate the mantissa output 608 and the exponent output 618 to form output 206 of the device 200 in FIG. 2. Herein, zero (+0), infinity (±∞), and non-numeric refer to the mathematical value or result. Implementations may choose the corresponding representations according to various encodings as standardized by an industrial standard (e.g., IEEE Std 754-2019) or as specified by a proprietary format.

Referring back to FIG. 3, in some embodiments, the operation 308 may instruct the device 300 to perform multiplication instruction without adjusting an exponent. Such an instruction is referred to as “Exponent-Unadjusted Multiplication.”

By switching among various ways to generate the output 206, as described earlier, the square root of an input operand (X) can be correctly computed by deploying devices 200 and 300. For example, when the input 202 is infinity (∞), the device 200 generates an infinity (∞) as the output 206. The device 300 performs the Exponent-Unadjusted Multiplication and multiplies X with R. The multiplication of ∞ (X) and ∞ (R) produces ∞. Thus, the device 300 generates an infinity (∞) as the output 310. The square root of infinity (∞) is infinity (∞). This can be represented by the following equation:

$$√ x {=}^{def} x * R$$

In addition to Exponent-Unbounded Reciprocal and Exponent-Unbounded Reciprocal Square Root instructions, the operation 204 may instruct the device 200 to perform reciprocal or reciprocal square root while honoring any exponent range as specified by a corresponding format, bit width, bias, encoding, compression, or a combination thereof and generate the output 206 accordingly. Such instructions are referred to as “Exponent-Bounded Reciprocal” and “Exponent-Bounded Reciprocal Square Root,” respectively. When performing Exponent-Bounded Reciprocal Square Root operation, the device 200 follows the common 1/√X equation for any input 202.

Additions of Exponent-Bounded Reciprocal and Exponent-Bounded Reciprocal Square Root enable the device 200 to be utilized independently from the device 300 and generate reciprocal or reciprocal square root as commonly expected. The device 200 can embody any of Exponent-Unbounded Reciprocal, Exponent-Unbounded Reciprocal Square Root, Exponent-Bounded Reciprocal, Exponent-Bounded Reciprocal Square Root, and/or other instructions. Example embodiments also allow an embodiment without operation 204. In these embodiments, the device 200 is an accelerator or extension.

In addition to Exponent-Adjusted Multiplication and Exponent-Unadjusted Multiplication, the operation 308 may instruct the device 300 to perform another instruction such as multiply-add by multiplying the first input 302 by the second input 304 and adding the third input 306 to a product from the multiplication to generate an output 310. The device 300 can embody any of Exponent-Adjusted Multiplication, Exponent-Unadjusted Multiplication, and/or other instructions. Example embodiments also allow for an embodiment without the operation 308. In these embodiments, the device 300 is an accelerator or extension.

Reciprocal or reciprocal square root can also be an extension to accelerate CPU, GPU, FPU, DSP, or another microprocessor (e.g., the microprocessor 106). Furthermore, reciprocal or reciprocal square root instructions can be (or be embodied within) an independent accelerator. An extension can be implemented in a similar way as an independent accelerator. As an extension or accelerator, example embodiments are embodied without an instruction or data fetch unit (e.g., the data fetch unit 110). In some embodiments, a microprocessor provides an operand to an extension or accelerator. The microprocessor may receive a result from the extension or accelerator. Any of the extensions, accelerators, and devices discussed herein may be a hardware device (e.g., a hardware accelerator).

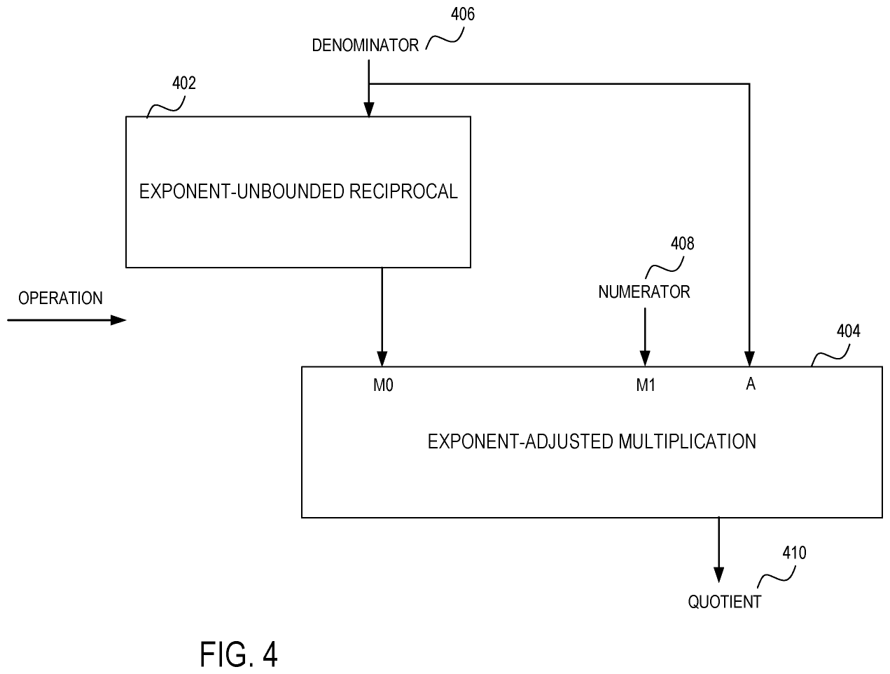

FIG. 4 is a block diagram illustrating a division extension, according to example embodiments. A first device 402 embodies Exponent-Unbounded Reciprocal and a second device 404 embodies Exponent-Adjusted Multiplication. A denominator (D) 406 is provided as an input to both the device 402 and the device 404. A numerator (N) 408 is provided to the device 404 only. The device 404 multiplies the numerator (N) 408 with an Exponent-Unbounded Reciprocal output from the device 402, according to example embodiments, and generates a quotient 410. In this embodiment, the denominator (D) 406 comprises a denominator exponent, a denominator mantissa, and, optionally, a denominator sign. In some embodiments, an exponent is adjusted by an exponent adjustment (A) to generate the quotient 410.

In the embodiment of FIG. 4, Exponent-Unbounded Reciprocal and Exponent-Adjusted Multiplication are shown being embodied as two separate devices 402 and 404. However, alternative embodiments may integrate (e.g., combine the functions of) the Exponent-Unbounded Reciprocal and Exponent-Adjusted Multiplication into a single device.

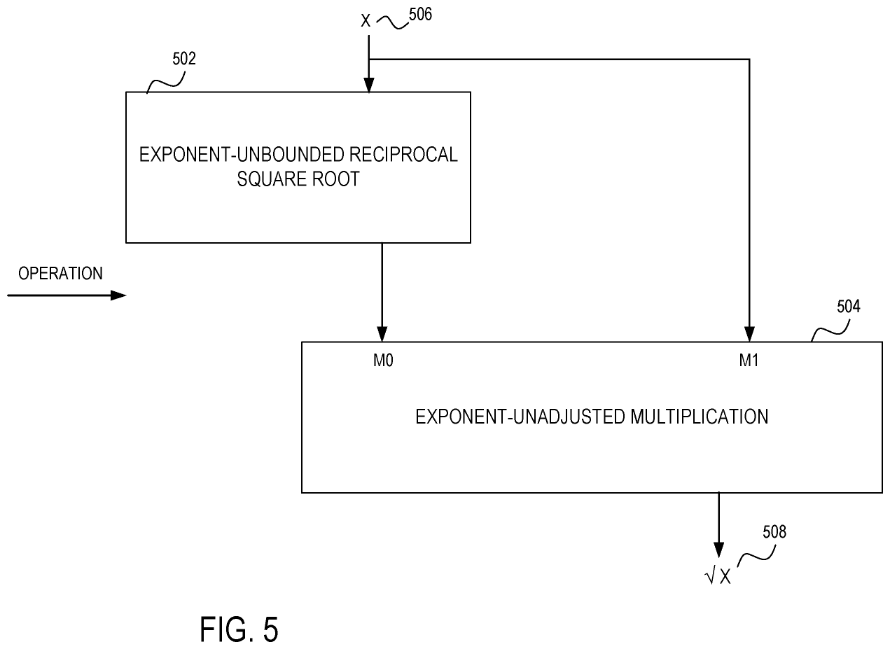

FIG. 5 is a block diagram illustrating an independent square root accelerator, according to example embodiments. A first device 502 embodies Exponent-Unbounded Reciprocal Square Root and a second device 504 embodies Exponent-Unadjusted Multiplication. An operand (x) 506 is provided as an input to both the first devices 502 and the second device 504. The second device 504 multiplies the operand (x) 506 by an Exponent-Unbounded Reciprocal Square Root output from the first device 502 and generates a square root 508.

In the embodiment of FIG. 5, Exponent-Unbounded Reciprocal Square Root and Exponent-Unadjusted Multiplication are showed being embodied as (or embodied within) two separate devices 502 and 504. However, alternative embodiments may integrate (e.g., combine the functions of) Exponent-Unbounded Reciprocal Square Root and Exponent-Unadjusted Multiplication into a single device.

FIG. 6 is a diagram illustrating components of an exemplary arithmetic logic unit 600, according to some example embodiments. The arithmetic logic unit 600 may be the arithmetic logic unit 120 of FIG. 1, a microprocessor extension, or an independent accelerator. The arithmetic logic unit 600 is configured to support any of Exponent-Unbounded Reciprocal, Exponent-Unbounded Reciprocal Square Root, Exponent-Bounded Reciprocal, and/or Exponent-Bounded Reciprocal Square Root instructions.

A reciprocal component 602 provides a reciprocal resultant based on a precomputed table, approximation, polynomial (e.g., Taylor Series), interpolation (e.g., Chebyshev, minimax), or a combination thereof. A reciprocal square root component 604 provides a reciprocal square root resultant based on a precomputed table, approximation, polynomial (e.g., Taylor Series), interpolation (e.g., Chebyshev, minimax), or a combination thereof. In one embodiment, the reciprocal square root component provides a reciprocal square root resultant (e.g., an output significand) with a value in a range of [1.0,2.0). The approximation, polynomial, and/or interpolation may use a small, precomputed table. In some embodiments, any of the precomputed tables may be lookup tables that are implemented with hardware decoders.

The detector 620 is configured to detect whether an input 612 is a zero (0), infinity (∞), or non-numeric (e.g., NaN in IEEE Std 754-2019) and provides the corresponding output when performing Exponent-Unbounded Reciprocal Square Root or other instruction. The selector 606 is configured to select an appropriate result. For example, the result may be selected according to an instructing signal from the CPU, GPU, FPU, DSP, or another microprocessor (e.g., the microprocessor 106). The output of the selector 606 is the output 608. In some embodiments, the selector 606 is implemented with a hardware mux.

When performing Exponent-Unbounded instructions, a first subtracter 610 subtracts a count of leading 0 bit(s) of significand from an exponent portion of the input 612 and generates a difference. When performing reciprocal square root instructions, the difference is right shifted by one (1) to truncate its least significant bit. A negater 614 changes a positive number to a negative number and, vice versa, to generate an “unbounded exponent.” An unbounded exponent is an exponent unbounded by a corresponding format, bit width, bias, or a combination thereof.

When performing Exponent-Unbounded Reciprocal and, optionally, Exponent-Unbounded Reciprocal Square Root instructions, a second subtracter 616 subtracts a minimum representable exponent from the output of the negater 614 based on the output of the negater 614 being less than the minimum representable exponent. Alternatively, the second subtracter 616 subtracts a maximum representable exponent from the output of the negater 614 based on the output of the negater 614 being greater than the maximum representable exponent. In some embodiments, the negater 614 and the second subtracter 616 can be implemented with hardware adders. In some embodiments, it is also possible to merge the negater 614 and the second subtracter 616 into a single hardware adder. The selector 622 may select a suitable corresponding output from the detector 620 if the input 612 is a zero (0), infinity (∞), or non-numeric (e.g., NaN in IEEE Std 754-2019) when performing Exponent-Unbounded Reciprocal Square Root or other instruction. The output of the selector 622 is an exponent output 618.

To maximize hardware component sharing, the arithmetic logic unit 600 of FIG. 6 can integrate reciprocal and reciprocal square root instructions into a single hardware device. Such a device may perform different instructions as instructed by a signal from the CPU, GPU, FPU, DSP, or another microprocessor (e.g., microprocessor 106), or as hardwired to a predetermined fixed instruction (e.g., reciprocal or reciprocal square root). The device 200 of FIG. 2 is an exemplary result of such a multifunctional hardware implementation.

To minimize hardware footprint, reciprocal instructions can be implemented separately as a smaller device, by removing the reciprocal square root component 604 and the selector 606. The device 402 in FIG. 4 is an exemplary result of such a smaller hardware reciprocal implementation. Likewise, reciprocal square root instruction can be implemented separately as a smaller device, by removing the second hardware subtracter 616 and the reciprocal component 602. The device 502 in FIG. 5 is an exemplary result of such a smaller hardware reciprocal square root implementation.

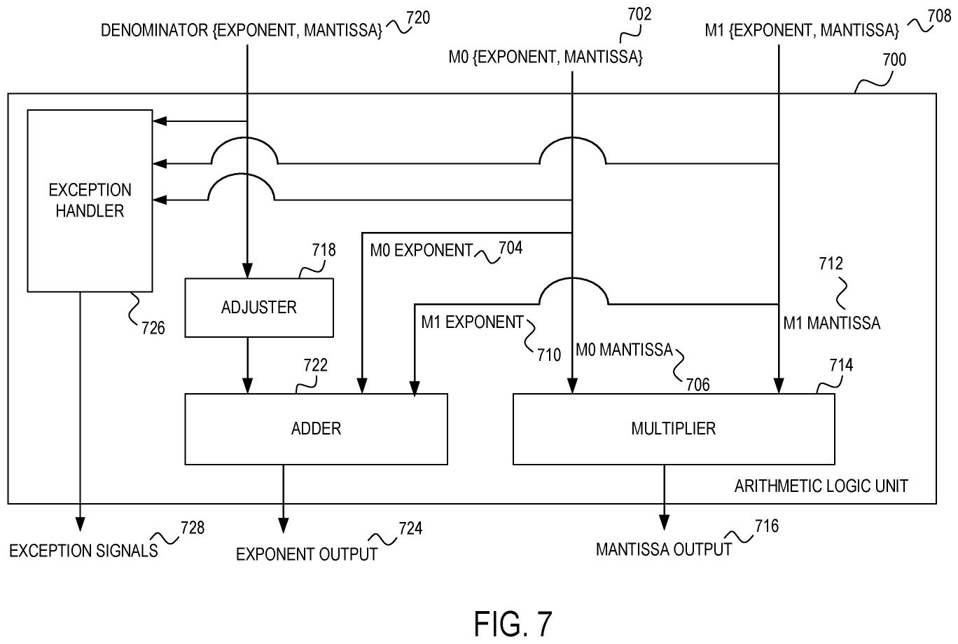

Referring now to FIG. 7, a block diagram illustrating components of an exemplary arithmetic logic unit 700, in accordance with further example embodiments, is shown. The arithmetic logic unit 700 may be the arithmetic logic unit 120 of FIG. 1, a microprocessor extension, or an independent accelerator. In example embodiments, the arithmetic logic unit 700 is configured to support Exponent-Adjusted Multiplication and Exponent-Unadjusted Multiplication. A first input multiplicand (M0) 702 includes an exponent 704 (MO exponent) and mantissa bits 706 (M0 mantissa). Likewise, a second input multiplicand (M1) 708 includes an exponent 710 (M1 exponent) and mantissa bits 712 (M1 mantissa). A hardware multiplier 714 multiplies the mantissa bits 706 (M0 mantissa) by the mantissa bits 712 (M1 mantissa) to generate a mantissa output 716.

When performing Exponent-Adjusted Multiplication, an adjuster 718 compares an exponent portion of a denominator 720 against a maximum representable exponent and counts an amount of leading 0s of denominator significand (e.g., portion of the denominator 720). If the exponent of the denominator 720 equals the maximum representable exponent, the adjuster 718 generates a minimum representable exponent (e.g., an exponent adjustment). If the amount of leading 0s of the denominator significand of the denominator 720 is greater than zero (0), the adjuster 718 generates a maximum representable exponent (e.g., an exponent adjustment). Otherwise, the adjuster 718 generates a zero (0). A hardware adder 722 sums up the exponent 704 (M0 exponent), the exponent 710 (M1 exponent), and the exponent adjustment from the adjuster 718 to generate an exponent output 724. When performing Exponent-Unadjusted Multiplication, the adjuster 718 generates a zero (0) resulting in no exponent adjustment.

In example embodiments, the adjuster 718 may generate the exponent adjustment in at least two alternative ways. In a first manner, if the denominator input 720 comprises a denominator sign (but not necessarily exponent or mantissa) and if Exponent-Unbounded instructions additionally generates a sign output which differs from the denominator sign when overflow or underflow occurs, the adjuster 718 may compare the Reciprocal or Reciprocal Square Root output sign against the denominator sign. The adjuster 718 generates a minimum representable exponent when the signs differ and the M0 exponent 704 (part of the input multiplicand 702) is negative. The adjuster 718 generates a maximum representable exponent based on the signs differing and the M0 exponent 704 being positive. Otherwise, the adjuster 718 generates zero (0).

In a second manner, if the denominator input 720 is unavailable, the adjuster 718 may check a least significant bit (LSB) of the Reciprocal or Reciprocal Square Root mantissa output (part of 702). Some embodiments preset a predetermined value as 0 or 1. The adjuster 718 generates a minimum representable exponent when the LSB differs from the predetermined value (e.g., 0 or 1) and the M0 exponent 704 is negative. The adjuster 718 generates a maximum representable exponent when the LSB differs from the predetermined value and the M0 exponent 704 is positive. Otherwise, the adjuster 718 generates zero (0).

Alternatively, when an unbounded exponent is available as part of the first input multiplicand (M0) 702, the arithmetic logic unit 700 does not have to comprise the adjuster 718, and the adder 722 can be a 2-input adder which sums up the M0 exponent 704 (the unbounded exponent) and the M1 exponent 710. As the unbounded exponent is available, no adjustment is necessary.

Optionally, the arithmetic logic unit 700 may further comprise an exception handler 726. The exception handler 726 checks the first input multiplicand (M0) 702, the second input multiplicand (M1) 708, and, optionally, the denominator input 720. The exception handler 726 may signal an invalid operation when any of the following is detected: 1) any of the inputs 702, 708, and 720 is a signaling non-numeric (e.g., signaling NaN in IEEE Std 754-2019); or 2) one of the inputs 702 and 708 represents 0 while the other one represents infinity. The exception handler 726 may signal a division by zero operation when one of the inputs 702 and 708 represents a non-zero finite number while the other one represents infinity.

To maximize hardware component sharing, the arithmetic logic unit 700 of FIG. 7 can integrate Exponent-Adjusted Multiplication and Exponent-Unadjusted Multiplication instructions into a hardware device with the multiplier 714 and an adder 722. Such a device may perform different instructions as instructed by a signal from the CPU, GPU, FPU, DSP, or another microprocessor (e.g., the microprocessor 106), or as hardwired to a predetermined fixed instruction (e.g., either Exponent-Adjusted Multiplication or Exponent-Unadjusted Multiplication). The device 300 of FIG. 3 is an example result of such a multifunctional hardware implementation.

To minimize hardware footprint, Exponent-Adjusted Multiplication instructions can be implemented separately as a smaller device, by hardwiring to perform Exponent-Adjusted Multiplication instruction. The device 404 in FIG. 4 is an exemplary result of such a smaller hardware Exponent-Adjusted Multiplication implementation. Likewise, Exponent-Unadjusted Multiplication instruction can be implemented separately as a smaller device, by disregarding the denominator 720, removing the adjuster 718, and supporting neither an unbounded exponent nor adjustment. The device 504 in FIG. 5 is an exemplary result of such a smaller hardware Exponent-Unadjusted Multiplication implementation.

Example embodiments allow for integrating Exponent-Unbounded Reciprocal and Exponent-Adjusted Multiplication into a single device, integrating Exponent-Unbounded Reciprocal Square Root and Exponent-Unadjusted Multiplication into a single device, or both. When embodying such an integration, the adder 722 of FIG. 7 can be a 2-input adder receiving the M1 exponent 710 and the unbounded exponent directly from the negater 614 of FIG. 6. The second subtractor 616 of FIG. 6 as well as the denominator 720 and the adjuster 718 can be eliminated.

The embodiments of FIG. 6 and FIG. 7 can be converted into a hardware description language (e.g., Verilog as defined by IEEE Std 1364). The description language is then synthesized and laid-out using synthesis and layout tools (e.g., Icarus Verilog) into a physical implementation using a technology-specific standard cell library. For example, a CMOS integrated circuit standard cell library developed by Virginia Tech for VLSI and Telecommunication Lab (VTVT) for a TSMC 0.25 um manufacturing process can be used. A semiconductor chip manufacturer (e.g., TSMC) can then fabricate silicon chips according to the physical implementation.

Using the VTVT standard cell library, Icarus Verilog may implement the first and second subtracters 610 and 616 and the adder 722 with “fulladder” cells, implement the negater 614 with “inv_1” cells, implement the selector 606 with “mux_2” cells, implement the adjuster 718 with “fulladder” and “nand4_4” cells, implement the multiplier 714 with “fulladder” and “and3_4” cells, and/or implement the reciprocal component 602 and the reciprocal square root component 604 with “nand4_2,” “fulladder,” “and3_2” cells, or a combination thereof. Any precomputed table (e.g., the reciprocal component 602 and reciprocal square root component 604) can be implemented as a read-only memory (ROM).

In example embodiments, GNU Octave, FreeMat, or other programming languages can be used to precompute reciprocal and reciprocal square root and store the resultants as predetermined tables in the reciprocal component 602 and the reciprocal square root element 604, respectively. Alternatively, approximation, polynomial (e.g., Taylor Series), interpolation (e.g., Chebyshev, minimax), or a combination thereof can be applied to generate outputs of the reciprocal component 602 and the reciprocal square root component 604.

In order to ensure the silicon chips are free of manufacturing defects the following operations can be deployed: (1) dividing 1.0*2\hat{ }127 by 1.0*2\hat{ }127; and/or (2) square root of 1.0*2\hat{ }−128.

Referring back to FIG. 4, the example embodiment of FIG. 4 may be utilized to divide 1.0*2\hat{ }127 by 1.0*2\hat{ }127. In binary32 format, 1.0*2\hat{ }127 is represented with an exponent valued as 127 and with a significand valued as 1.0. The device 402 receives the denominator 406 (e.g., 1.0*2\hat{ }127). As the device 402 is implemented (e.g., using the embodiment of FIG. 6), the {exponent, mantissa} input 612 receives 127 as the input exponent and 1.0 as the input significand. By performing Exponent-Unbounded Reciprocal, the first subtracter 610 subtracts 0 (e.g., the count of leading 0s of significand) from the exponent (e.g., 127) and generates 127 as the difference. The negater 614 negates 127 and forwards −127 to the second subtracter 616. As −127 is less than the minimum representable exponent (e.g., −126), the second subtracter 616 subtracts −126 from −127 and sends −127-(−126) or −1 to selector 622. The selector 622 forwards −1 as an exponent output 618.

The reciprocal component 602 sends 1.0 (e.g., reciprocal of 1.0) to the selector 606. By performing Exponent-Unbounded Reciprocal, the selector 606 selects the output from the reciprocal component 602 and sends 1.0 as the mantissa output 608.

As the device 404 is implemented (e.g., using the embodiment of FIG. 7), the M0 input 702 receives −1 as an exponent 704 and 1.0 as mantissa bits 706. The M1 input 708 receives 127 as an exponent 710 and 1.0 as mantissa bits 712, representing the numerator 1.0*2\hat{ }127. The denominator input 720 receives 127 as an exponent and 1.0 as a significand. Since the denominator exponent is equal to the maximum representable exponent, the adjuster 718 generates the minimum exponent −126 and sends it to the adder 722. The adder 722 sums up −1 (e.g., M0 exponent), 127 (e.g., M1 exponent), and −126 (e.g., from the adjuster 718) and sends 0 as an exponent output 724.

The multiplier 714 multiplies the mantissa bits 706 (e.g., 1.0) by the mantissa bits 712 (e.g., 1.0) and sends 1.0 as a mantissa output 716. By combining the exponent output 724 (e.g., 0) and mantissa output 716 (e.g., 1.0) together, 1.0*2\hat{ }0 or 1.0 is the correct result of dividing 1.0*2\hat{ }127 by 1.0*2\hat{ }127.

Referring now to FIG. 5, the embodiment of FIG. 5 may be utilized to find the square root of 1.0*2\hat{ }−128. In binary32 format, 1.0*2\hat{ }−128 is represented with an exponent valued as −126 and a significand valued as 0.25. The device 502 receives an input 506 (e.g., 0.25*2\hat{ }−126). As the device 502 is implemented (e.g., using the embodiment of FIG. 6), the {exponent, mantissa} input 612 receives −126 as the input exponent and 0.25 as the input significand. Since performing Exponent-Unbounded Reciprocal Square Root, the first subtracter 610 subtracts 2 from −126 to account for two (2) leading 0s in the significand, truncates a least significant bit of −128 (e.g., −126−2) and sends a resulting −64 to the negater 614. The negater 614 negates −64 and forwards 64 to the second subtracter 616. As 64 is not less than the minimum representable exponent (e.g., −126) or greater than the maximum representable exponent (e.g., 127), the second subtracter 616 simply forwards 64 to the selector 622. The selector 622 then forwards 64 as the exponent output 618.

The reciprocal square root component 604 sends 1.0 (e.g., reciprocal square root of normalized 0.25) to the selector 606. Since performing Exponent-Unbounded Reciprocal Square Root, the selector 606 selects the output form the reciprocal square root component 604 and sends 1.0 as the mantissa output 608.

As the device 504 is implemented (e.g., using the embodiment of FIG. 7), the M0 input 702 receives 64 as an exponent 704 and 1.0 as mantissa bits 706. The M1 input 708 receives −126 as an exponent 710 and 0.25 as mantissa bits 712, representing 1.0*2\hat{ }−128. By performing Exponent-Unadjusted Multiplication, the adjuster 718 generates 0 and sends it to the adder 722. The adder 722 sums up 64 (e.g., M0 exponent), −128 (e.g., M1 exponent) and 0 (e.g., from the adjuster 718) and sends −64 as an exponent output 724.

The multiplier 714 multiplies the mantissa bits 706 (1.0) by the mantissa 712 (1.0) and sends 1.0 as the mantissa output 716. By combining the exponent output 724 (−64) and mantissa output 716 (1.0) together, 1.0*2\hat{ }−64 is the correct result of √1.0*2\hat{ }−128.

FIG. 8 illustrates components of a machine 800, according to some example embodiments, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 8 shows a diagrammatic representation of the machine 800 in the example form of a computer device (e.g., a computer) and within which instructions 824 (e.g., software, a program, an application, an applet, an app, or other executable code) for causing the machine 800 to perform any one or more of the methodologies discussed herein may be executed, in whole or in part. In one embodiment, the instructions 824 can transform the general, non-programmed machine 800 into a particular machine (e.g., specially configured machine) programmed to carry out the described and illustrated functions in the manner described.

In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824 (sequentially or otherwise) that specify actions to be taken by that machine. Further, while only a single machine is illustrated, the term “machine” shall also be taken to include comprise a collection of machines that individually or jointly execute the instructions 824 to perform any one or more of the methodologies discussed herein.

The machine 800 comprises a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The processor 802 may contain microcircuits that are configurable, temporarily or permanently, by some or all of the instructions 824 such that the processor 802 is configurable to perform any one or more of the methodologies described herein, in whole or in part. For example, a set of one or more microcircuits of the processor 802 may be configurable to execute one or more modules (e.g., software modules) or instructions.

The machine 800 may further comprise a graphics display 810 (e.g., a plasma display panel (PDP), a light emitting diode (LED) display, a liquid crystal display (LCD), a projector, or a cathode ray tube (CRT), or any other display capable of displaying graphics or video). The machine 800 may also comprise an input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a sound card, an amplifier, a speaker, a headphone jack, or any suitable combination thereof), and a network interface device 820.

The storage unit 816 comprises a machine-storage medium 822 (e.g., a tangible machine-storage medium) on which is stored the instructions 824 (e.g., software) embodying any one or more of the methodologies or functions described herein. The instructions 824 may also reside, completely or at least partially, within the main memory 804, within the processor 802 (e.g., within the processor's cache memory), or both, before or during execution thereof by the machine 800. Accordingly, the main memory 804 and the processor 802 may be considered as machine-storage media (e.g., tangible and non-transitory machine-storage media). The instructions 824 may be transmitted or received over a network 826 via the network interface device 820.

In some example embodiments, the machine 800 may be a portable computing device and have one or more additional input components (e.g., sensors or gauges). Examples of such input components include comprise an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

### Executable Instructions and Machine-Storage Medium

The various memories (e.g., 804, 806, and/or memory of the processor(s) 802) and/or storage unit 816 may store one or more sets of instructions and data structures (e.g., software 824) embodying or utilized by any one or more of the methodologies or functions described herein. These instructions, when executed by processor(s) 802 cause various operations to implement the disclosed embodiments.

As used herein, the terms “machine-storage medium,” “device-storage medium,” “computer-storage medium” (referred to collectively as “machine-storage medium 822”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 822 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 822 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 824 may further be transmitted or received over a communications network 826 using a transmission medium via the network interface device 820 and utilizing any one of a number of well-known transfer protocols (e.g., HTTP). Examples of communication networks 826 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” shall be taken to include any intangible medium that is capable of storing, encoding, or carrying instructions 824 for execution by the machine 800, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-storage medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device (e.g., a register file) to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines comprising processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

### Examples

Example 1 is an integrated circuit for accelerating operations associated with a microprocessor. The integrated circuit comprises an accelerator that receives an input operand comprising an input exponent and an input mantissa and performs operations to generate an output operand, the accelerator comprising a selector that selects the output, a reciprocal square root component that provides a resultant with a value in a range of [1.0,2.0) to the selector; and a detector that detects whether the input operand is zero, infinity, or non-numeric and provides a value to the selector based on the input operand being zero, infinity, or non-numeric.

In example 2, the subject matter of example 1 can optionally comprise wherein the accelerator is an execution unit and the integrated circuit further comprises an instruction decode unit that decodes instructions comprising a reciprocal square root instruction; and a data fetch unit that accesses the input operand based on the reciprocal square root instruction.

In example 3, the subject matter of any of examples 1-2 can optionally comprise wherein the instruction decode unit and the data fetch unit are comprised within a single unit.

In example 4, the subject matter of any of examples 1-3 can optionally comprise wherein the reciprocal square root component includes a precomputed table.

In example 5, the subject matter of any of examples 1-4 can optionally comprise wherein the accelerator further comprises a subtracter and a negater that generates an unbounded exponent based on the input exponent.

In example 6, the subject matter of any of examples 1-5 can optionally comprise wherein the selector selects the output representing positive zero (+0) based on the input operand being zero (±0).

In example 7, the subject matter of any of examples 1-6 can optionally comprise wherein the selector selects the output representing infinity (+∞) based on the input operand being infinity (+∞).

In example 8, the subject matter of any of examples 1-7 can optionally comprise wherein the selector selects the output representing non-numeric (e.g., NaN in IEEE 754-2019) based on the input operand being negative non-zero.

In example 9, the subject matter of any of examples 1-8 can optionally comprise wherein the selector selects the output representing non-numeric (e.g., NaN in IEEE 754-2019) based on the input operand being non-numeric (e.g., NaN in IEEE 754-2019).

In example 10, the subject matter of any of examples 1-9 can optionally comprise wherein the selector selects the resultant from the reciprocal square root component as the output based on the input operand being positive non-zero finite.

In example 11, the subject matter of any of examples 1-10 can optionally comprise wherein the accelerator is further configured to perform a multiplication operation using the resultant and a second input operand by multiplying the resultant and the second input operand to obtain a multiplication result, the multiplication result comprising a result exponent and a result mantissa.

Example 12 is an integrated circuit for accelerating operations associated with a microprocessor. The integrated circuit comprises a multiplication device that receives a first operand and a second operand, the multiplication device configured to generate a result based on the first operand and the second operand, the multiplication device comprising a multiplier that multiplies the first operand by the second operand to generate the result; and an exception handler that checks the first operand and the second operand for zero, infinity, or non-numeric and signals an exception based on the check of the first operand and the second operands.

In example 13 the subject matter of example 12 can optionally comprise wherein the exception comprises a division by zero operation based on one of the first operand or the second operand being non-zero finite and the other being infinity.

Example 14 is a method for accelerating operations associated with a microprocessor. The method comprises receiving, by an accelerator, an input operand comprising an input exponent and an input mantissa; generating, by the accelerator, an output based on the input operand, the generating including determining, using a reciprocal square root component, a resultant with a value in a range of [1.0,2.0); providing the resultant to a selector; detecting, by a detector, whether the input operand is zero, infinity, or non-numeric; based on the input operand being zero, infinity, or non-numeric, providing a value from the detector to the selector; selecting, by the selector, the output based on the resultant and the value from the detector; and transmitting the output.

In example 15, the subject matter of example 14 can optionally comprise wherein the selecting the output comprises selecting an output representing positive zero based on the input operand being zero.

In example 16, the subject matter of any of examples 14-15 can optionally comprise wherein the selecting the output comprises selecting an output representing infinity (+∞) based on the input operand being infinity (+∞).

In example 17, the subject matter of any of examples 14-16 can optionally comprise wherein selecting the output comprises selecting an output representing non-numeric based on the input operand being negative non-zero.

In example 18, the subject matter of any of examples 14-17 can optionally comprise wherein the selecting the output comprises selecting an output representing non-numeric based on the input operand being non-numeric.

In example 19, the subject matter of any of examples 14-18 can optionally comprise wherein the generating further comprises generating an unbounded exponent based on the input exponent.

In example 20, the subject matter of any of examples 14-19 can optionally comprise wherein the selecting the output comprises selecting the resultant from the reciprocal square root component as the output based on the input operand being positive non-zero finite.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing, computer arithmetic, or mathematical algorithm arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “sign,” “exponent,” “mantissa,” “significand” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” “subtracting,” “negating,” “forwarding,” “inverting,” “sending,” “generating,” “selecting,” “summing,” “multiplying,” “adjusting,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. An integrated circuit comprising:
an accelerator that receives an input operand comprising an input exponent and an input mantissa and performs operations to generate an output, the accelerator comprising:
a selector that selects the output;
a reciprocal square root component that provides a resultant with a value in a range of [1.0,2.0) to the selector; and
a detector that detects whether the input operand is zero, infinity, or non-numeric and provides a value to the selector based on the input operand being zero, infinity, or non-numeric.

2. The integrated circuit of claim 1, wherein the accelerator is an execution unit and the integrated circuit further comprises:
an instruction decode unit that decodes instructions comprising a reciprocal square root instruction; and
a data fetch unit that accesses the input operand based on the reciprocal square root instruction.

3. The integrated circuit of claim 2, wherein the instruction decode unit and the data fetch unit are comprised within a single unit.

4. The integrated circuit of claim 1, wherein the reciprocal square root component includes a precomputed table.

5. The integrated circuit of claim 1, wherein the accelerator further comprises a subtracter and a negater that generates an unbounded exponent based on the input exponent.

6. The integrated circuit of claim 1, wherein the selector selects the output representing positive zero based on the input operand being zero.

7. The integrated circuit of claim 1, wherein the selector selects the output representing infinity (+∞) based on the input operand being infinity (+∞).

8. The integrated circuit of claim 1, wherein the selector selects the output representing non-numeric based on the input operand being negative non-zero.

9. The integrated circuit of claim 1, wherein the selector selects the output representing non-numeric based on the input operand being non-numeric.

10. The integrated circuit of claim 1, wherein the selector selects the resultant from the reciprocal square root component as the output based on the input operand being positive non-zero finite.

11. The integrated circuit of claim 1, wherein the accelerator is further configured to perform a multiplication operation using the resultant and a second input operand by multiplying the resultant and the second input operand to obtain a multiplication result, the multiplication result comprising a result exponent and a result mantissa.

12. An integrated circuit comprising:
a multiplication device that receives a first operand and a second operand, the multiplication device configured to generate a result based on the first operand and the second operand, the multiplication device comprising:
a multiplier that multiplies the first operand by the second operand to generate the result, and
an exception handler that checks the first operand and the second operand for zero, infinity, or non-numeric and signals an exception based on the check of the first operand and the second operand.

13. The integrated circuit of claim 12, wherein the exception comprises a division by zero operation based on one of the first operand or the second operand being non-zero finite and the other being infinity.

14. A method comprising:
receiving, by an accelerator, an input operand comprising an input exponent and an input mantissa;
generating, by the accelerator, an output based on the input operand, the generating including:
determining, using a reciprocal square root component, a resultant with a value in a range of [1.0,2.0);
providing the resultant to a selector;
detecting, by a detector, whether the input operand is zero, infinity, or non-numeric;
based on the input operand being zero, infinity, or non-numeric, providing a value from the detector to the selector; and
selecting, by the selector, the output; and
transmitting the output.

15. The method of claim 14, wherein the selecting the output comprises selecting an output representing positive zero based on the input operand being zero.

16. The method of claim 14, wherein the selecting the output comprises selecting an output representing infinity (+∞) based on the input operand being infinity (+∞).

17. The method of claim 14, wherein the selecting the output comprises selecting an output representing non-numeric based on the input operand being negative non-zero.

18. The method of claim 14, wherein the selecting the output comprises selecting an output representing non-numeric based on the input operand being non-numeric.

19. The method of claim 14, wherein the generating further comprises generating an unbounded exponent based on the input exponent.

20. The method of claim 14, wherein the selecting the output comprises selecting the resultant from the reciprocal square root component as the output based on the input operand being positive non-zero finite.
